(19) United States
(12) Patent Application Publication
(10) Pub. No.: US 2020/0372496 A1
(43) Pub. Date: Nov. 26, 2020

(54) SYSTEM AND METHOD FOR VALIDATION OF BUSINESS TRANSACTIONS

(71) Applicant: Clear Labs Israel Ltd., Tel Aviv (IL)

(72) Inventors: Gal HOCHBERG, Tel Aviv (IL); Eran HAGGIAG, Tel Aviv (IL)

(73) Assignee: Clear Labs Israel Ltd., Tel Aviv (IL)

(21) Appl. No.: 16/883,337

(22) Filed: May 26, 2020

Related U.S. Application Data
(60) Provisional application No. 62/852,028, filed on May 23, 2019.

(51) Int. Cl. G06Q 20/36; H04L 9/06; H04L 9/32

(52) U.S. Cl. CPC G06Q 20/3674; H04L 9/3213; H04L 9/0637

(57) ABSTRACT

A system and method for validating an authenticity of an item to be purchased in a transaction are provided. The method includes receiving a request for a purchase of at least one item from a purchasing node, and requesting at least one authentication tokens from a token generator. The at least one authentication token is generated based on a ledger, and each of the at least one authentication token corresponds to one of the at least one item to be purchased. The method also includes sending the at least one authentication token to a provider node, performing a verification of the at least one authentication token for authentication of the provider node as a legitimate source, and upon verification of the at least one authentication tokens completing a purchase of the item.

### CROSS-REFERENCE TO RELATED APPLICATIONS

This application claims the benefit of U.S. Provisional Application No. 62/852,028 filed on May 23, 2019, the contents of which are hereby incorporated by reference. All of the applications referenced above are herein incorporated by reference.

### TECHNICAL FIELD

The disclosure generally relates to on-line electronic transactions and more particularly to the verification of authenticity of goods purchased on-line.

### BACKGROUND

Performing business transactions, for example, over the Internet or over the worldwide web (WWW), have become a common occurrence. Users connect through, for example, a web browser and perform a transaction. Users do not always realize the complexity of the supply chain of the goods purchased, physical, such as clothes, machinery, cutlery, and other items, or virtual, such as a creation of a communication link between the user node and a destination node. The goods, whatever they may be, may transfer through several intermediary nodes in order for a user in order to complete a transaction.

Consider a bag purchase from a supplier A. Rarely is the case where a user purchases the item directly from the supplier. Rather, the bag is supplied through one or more intermediaries, each taking their own cut and having their business relations between the previous node and the next node on the way. A transaction for the purchase of the bag may happen from an intermediary supplier providing the bag to the user, but who is not the original supplier of the goods, and may not even have direct contact with such a supplier. That is, that intermediary node enables the purchase of the bag by buying the same bag from another intermediary supplier. Typically, such transactions occur at least partially on-line so an intermediary node may initiate the purchase of a quantity of like bags from another intermediary supplier, or for that matter from the supplier, and then offer to sell the same bag, preferably at a higher price to make a profit, to the next intermediary node or, to a user node.

FIGS. 1A through 1C provide a schematic description of the possible connectivity between a buyer node (BN) and a supplier node (SN) when connecting on-line for the performance of a transaction. In FIG. 1A the BN communicates directly with the SN. It should be noted however that while this is actually the case, it is not necessarily known for sure by the BN as such a SN may be an imposter, a fraudulent node, or an SN that sells forged products as if they are original ones. In FIG. 1B a case of a single intermediary node (IN) is shown. The BN performs a transaction with the IN for the supply of certain goods while the IN, separately of the communication with BN performs a transaction with the SN for the purpose of purchasing the goods. FIG. 1C shows a furtherly remote case where the BN is engaged with a transaction for the purchase of goods from an INi. The INi purchases the goods directly or indirectly from another intermediary node, for example INj, and INj performs the purchase of the goods from the SN. The payment link may be used to complete the transaction. Secure transactions are made possible by different and sophisticated anti-fraud solutions that attempt to ensure that the payment is secure and reaches safely its destination. For the purpose of this discussion the BN is the final node to which a purchase of goods are directed to, (i.e., the last in the chain of supply); the SN is the actual supplier of the goods, (i.e., the first in the chain of supply); and, IN are any nodes that may be communicatively connected between the SN and the BN for the purpose of performing the purchase of goods.

However, there is a flaw in this process. When a product changes hands on its way to the user node any one on the way may provide the next node a product that is not the one actually intended to be purchased. A counterfeit product may be provided instead of an original product of higher quality, richer features, or higher value.

In view of the above discussion, there is a need for bot detection that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for validating an authenticity of an item to be purchased in a transaction, including receiving a request for a purchase of at least one item from a purchasing node, and requesting at least one authentication tokens from a token generator. The at least one authentication token is generated based on a ledger, and each of the at least one authentication token corresponds to one of the at least one item to be purchased. The method also includes sending the at least one authentication token to a provider node, performing a verification of the at least one authentication token for authentication of the provider node as a legitimate source, and upon verification of the at least one authentication tokens completing a purchase of the item.

Certain embodiments disclosed herein also include a non-transitory computer readable medium having stored thereon instructions for causing a processing circuitry to execute a process, including receiving a request for a purchase of at least one item from a purchasing node, and requesting at least one authentication tokens from a token generator. The at least one authentication token is generated based on a ledger, and each of the at least one authentication token corresponds to one of the at least one item to be purchased. The method also includes sending the at least one authentication token to a provider node, performing a verification of the at least one authentication token for authentication of the provider node as a legitimate source, and upon verification of the at least one authentication tokens completing a purchase of the item.

Certain embodiments disclosed herein also include a method for validating an authenticity of an item to be purchased in a transaction, including receiving a request for purchasing one or more goods from a provider node, determining whether an authentication token generated based on a ledger has been received, and upon determining that the authentication token has been received, completing the transaction.

Certain embodiments disclosed herein also include a system for validating an authenticity of an item to be purchased in a transaction, the system includes a processing circuitry, and a memory. The memory contains instructions that, when executed by the processing circuitry, configure the system to receive a request for a purchase of at least one item from a purchasing node, and request at least one authentication tokens from a token generator, The at least one authentication token is generated based on a ledger, and each of the at least one authentication token corresponds to one of the at least one item to be purchased, send the at least one authentication token to a provider node. The system also performs a verification of the at least one authentication token for authentication of the provider node as a legitimate source; and upon verification of the at least one authentication tokens, completes a purchase of the item.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1A is a schematic illustration of a buyer node (BN) and a supplier node (SN) performing a direct purchase transaction there between.

FIG. 1B is a schematic illustration of a buyer node BN) and a supplier node (SN) performing an indirect purchase transaction there between using an intermediary node (IN).

FIG. 1C is a schematic illustration of a buyer node BN) and a supplier node (SN) performing an indirect purchase transaction there between using a plurality of intermediary nodes (INs).

FIG. 2 is a schematic diagram of a system for clearing of business transactions using token according to an embodiment.

FIG. 3 is a flowchart of an operation of a seller node (SN) according to an embodiment.

FIG. 4 is a flowchart of an operation of a purchaser at a buyer node (BN) or Intermediary Node (IN) according to an embodiment.

FIG. 5 is a schematic diagram of an authenticity validation system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

When performing an on-line transaction that includes the provisions of physical or virtual goods there is a need to verify the authenticity of the goods themselves. Therefore, a system and methods thereof provide for an authentication token that is generated by a supplier node for each good provided to a buyer node or an intermediary node. The token may be used to verify the authenticity of the goods as control over the supplied good is transferred from the supplier to the buyer. Upon initiation of a transaction request by a buyer node to purchase a good, an authentication token is received by the user node. Similarly, for every good sold by the supplier node, a corresponding token is provided for authentication purposes. The buyer node can then determine the authenticity of the good to be purchased. Payment may be authorized thereafter upon completion of order or delivery of the goods.

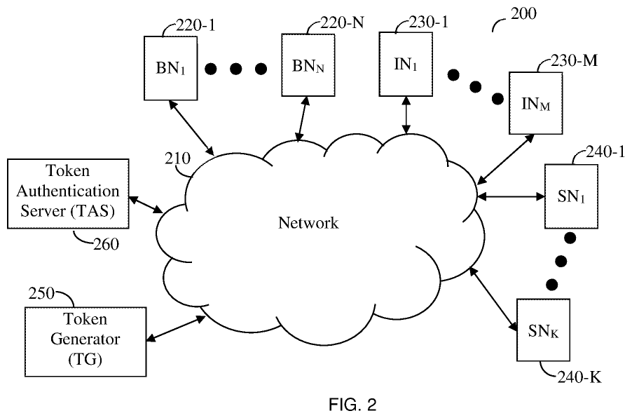

FIG. 2 is a schematic network diagram 200 utilized to describe the various embodiments of clearing of business transactions using token. As shown in FIG. 2, a network 210 allows for communications between components connected to the network 210. The network 210 may include a local area network (LAN), a wide area network (WAN), a metro area network (MAN), the Internet, the worldwide web (WWW), in a variety of technological implementations and combinations thereof, which may further include wired and wireless communications. The network 210 is connected to one or more buyer nodes (BNs) 220, for example BNs 220-1 through 220-n, where ‘n’ is an integer equal to or greater than ‘1’ (hereinafter BN 220). In an example embodiment, one or more intermediary nodes (INs) 230, for example INs 230-1 through 230-m (hereinafter IN 230), where ‘m’ is an integer equal to or greater than ‘0’, are communicatively connected to the network 210. One or more supplier nodes (SNs) 240, for example SNs 240-1 through 240-k (hereinafter SN 240), where ‘k’ is an integer equal to or greater than ‘1’, are communicatively connected to the network 210. A token generator (TG) 250 is communicatively connected to the network 210.

It should be appreciated that the TG 250 may be a stand-alone component. However, other implementations are possible, including, but not limited to, the integration of the TG 250 as an integral component of any one of the SNs 240. The functionality of the TG 250 is provided herein in greater detail. A token authentication server (TAS) 260, adapted for the authentication of tokens generated by the TG 250 is further communicatively connected to the network 210. Note that the TAS 260 may be a stand-alone component. However, other implementations are possible, including, but not limited to, the integration of a TAS 260 as a component of any one of the SNs 240.

The TAS 260 is configured to perform the various embodiment disclosed herein, In an embodiment, the TAS 260 is configured to authenticate authentication tokens that are registered therein, and therefore can provide for objective clearance of token produced for a particular SN 240. That is, a SN 240, for example, SN 240-1, owned by a known brand name entity, would register its authorization tokens with the TAS 260. The authorization of the tokens ensures that an imposter node would not be able to have the authorization tokens it issues as those belonging to the original brand name entity. Both TG 250 and TAS 260 may have distributed implementations thereof.

According to an embodiment, when an SN 240 provides certain goods to an entity purchasing goods therefrom, the TG 250 is configured to further generate tokens that enable the authentications of the goods sold. For example, considering a case where bags are sold. The SN 240 communicates with the TG 250 to generate authentication tokens in a number that correspond to the number of goods provided. The tokens may contain information therein that, upon a request for authentication, it may be possible to authenticate that the goods are from that particular supplier. A variety of token generation methods may be used for this purpose, making use of a ledger to track such authentication tokens. The ledger may include, database ledgers, immutable ledgers or fault tolerant ledgers. Such ledgers may include but are not limited to blockchains. In one embodiment, the ledgers are distributed ledgers.

It should be noted that the tokens do not have to correspond one-to-one for each item sold. In fact, fungible tokens are possible in an embodiment. That is, if in the example of the bags, ten bags are sold by the SN 240-1 to a BN 220, for example BN 220-1, then ten authentication tokens may be generated but they are not associated to the ten bags on a one-to-one basis. Rather, each token may be associated to any one of the ten bags.

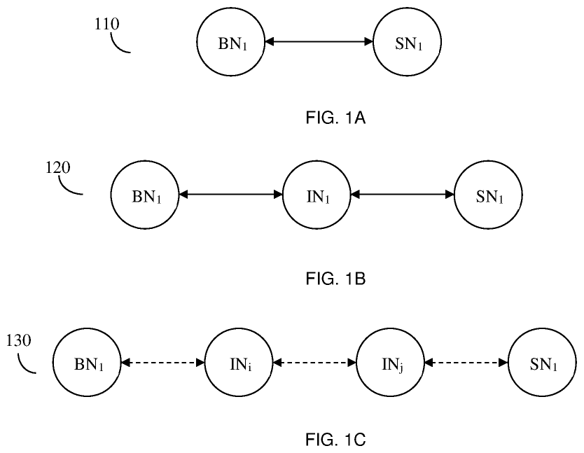

Consider the case of a communication case shown in FIG. 1B, where BN would correspond for example to BN 220-1; IN to IN 230-1; and, SN to SN 240-1. Upon a request by IN 230-1 to purchase, for example, ten bags beyond the purchase process, the SN 240-1 will further provide to the IN 230-1 ten authentication tokens that were generated by the TG 250.

The IN 230-1 may now perform an authentication process to verify that the goods bought are authentic by simply authenticating each token by communicating with the TAS 260. Now, when the BN 220-1 attempts to purchase one of the ten bags the IN 230-1, the payment process also provides the user with one of the ten tokens. Passing that token transfers the token in the ledger from the IN 230-1 to the BN 220-1. Now, the user can verify the token received by, for example, communicating with the TAS 260, and upon approval of the payment, the token remains with the BN 220-1. Tokens may be programmed to be returned if the purchase is not approved within a predetermined period of time, or, be allowed to expire.

While a physical good has been described herein, embodiments for performing token generation and authentication for virtual goods, (e.g., gift cards, phone calls, and other transactions that “live” only in the virtual world of electronic communication) may also be within the scope of the embodiment.

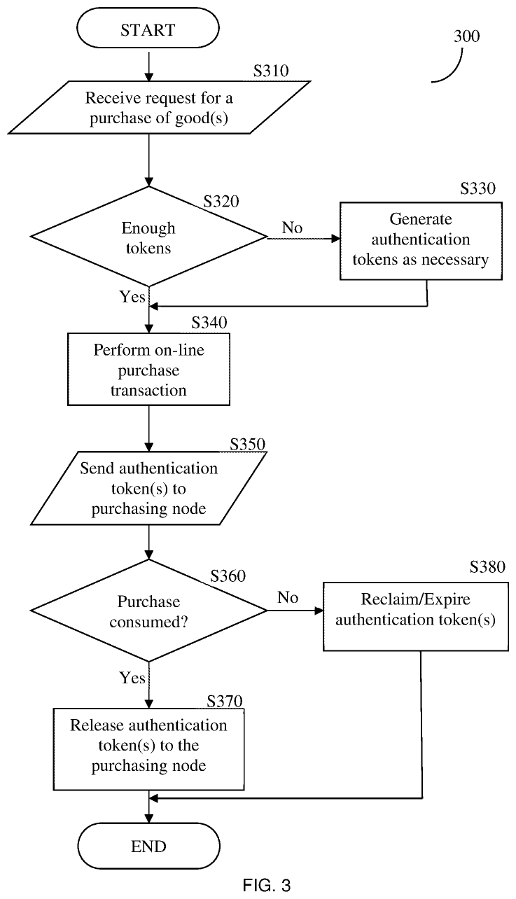

FIG. 3 depicts an example flowchart 300 of an operation of a seller node (SN) 240 according to an embodiment. FIG. 3 will be described with reference to the various elements shown in FIG. 2.

At S310, a request is received by the SN 240, for example SN 240-1, from a purchasing node, which may be a BN 220, for example BN 220-1, or an IN 230, for example IN 230-1, for a purchase. In S320, it is checked whether there are enough authentication tokens available for the goods. If so, execution continues with S340; otherwise, execution continues with S330.

At S330, authentication tokens are generated, for example by TG 250, in an amount requested by the SN 240-1. In one embodiment, at anytime, no more than the necessary amount of authentication tokens needed for completion of the transaction is generated. That is, one token is generated per one item to be purchased. At S340, the transaction that was initiated is processed by the SN 240-1. Then, at S350, the authentication token, (or tokens when multiple items are purchased), is sent to the purchasing node. At S360, it is checked if the purchase process has been consumed. If so, execution continues with S370. Otherwise, execution continues with S380. At S370, the authentication token, or tokens, are released to the purchasing node. Thereafter execution terminates. At S380, the authentication tokens are either reclaimed or otherwise made to expire as the case may be, and thereafter execution terminates.

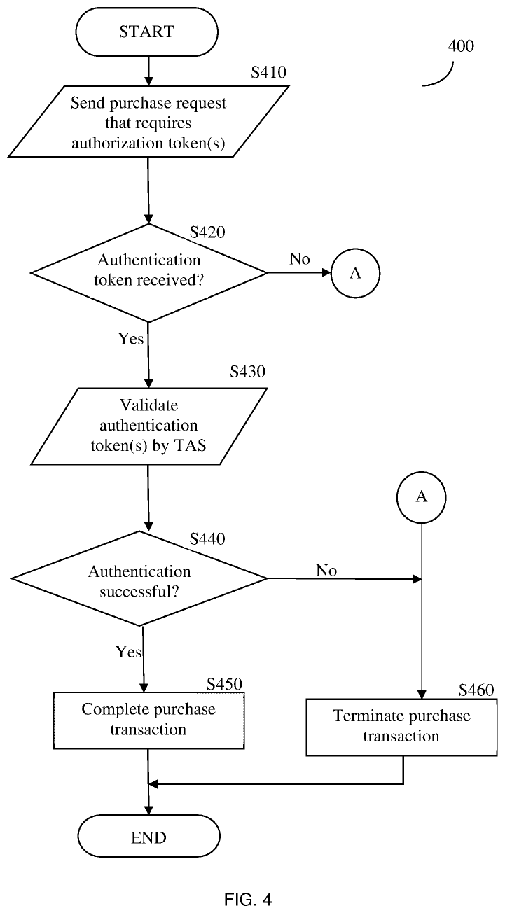

FIG. 4 is an example flowchart 400 of an operation of a purchaser by a purchasing node according to an embodiment. FIG. 3 will be described with reference to the various elements shown in FIG. 2. The purchasing node may be a BN 220 or IN 230.

At S410, a request for purchasing one or more goods is sent from a purchasing node, to a provider node. In S420, the purchasing node checks whether an authentication token has been received. If so, execution continues with S430. Otherwise, execution continues with S460.

At S430, a validation process of the token, or tokens, received from the provider node is performed. Such a validation may take place using the TAS 260. At S440, it is checked whether the authentication was successful. If so, execution continues with S450. Otherwise, execution continues with S460.

At S450, the transaction process is continued to completion (which may include the case where the purchasing node declines the purchase thereby, triggering step S380 by the provider node as explained herein), after which execution terminates. At S460, the purchase process for an inability to receive a proper authentication token or even a potential fraud attempt may be discontinued. In one embodiment, at S460 an alert is generated to indicate a potential fraud in the sales of the goods.

One of ordinary skill in the art would appreciate that according to an embodiment, the association between the authentication tokens and the goods is by the manufacturer, or originator of the goods. The association is therefore enforced by the SN 240, which does not produce more tokens than products, thus enabling the validation of the goods throughout the supply chain. Validation may be maintained anonymously, thus preventing direct access by those who do not have direct access to the SN 240.

It should also be further noted that the authentication tokens are owned at any given time by no more than one entity. Therefore, the transfer of the authentication token is sufficient to certify that the provider had authentic goods. It should be further noted that in one embodiment only the authentication token for the goods is used for the purpose of authentication, while the actual purchase is performed using other available transaction elements. For example, a transaction may be initiated through a phone call where a buyer speaks to a seller, but the confirmation of the authenticity of the goods being sold is performed using the techniques discussed herein.

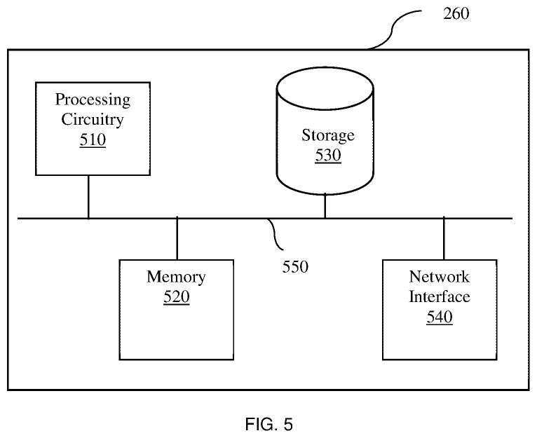

FIG. 5 is an example block diagram of the TAS 260 according to an embodiment. The

TAS 260 includes a processing circuitry 510 coupled to a memory 520, a storage 530, and a network interface 540. In an embodiment, the components of the system 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the TAS 260 to communicate with BN 220, IN 230, SN 240 for the purpose of, for example, receiving data, sending data, and the like. Further, the network interface 540 allows the TAS 260 to communicate with the TG 250 for the purpose of generating and authenticating the authentication tokens.

It should be understood that the embodiments described herein are not limited to the specific architecture illustrated in FIG. 5, and other architectures may be equally used without departing from the scope of the disclosed embodiments. Further, the architecture shown in FIG. 5 can be utilized to implement any node shown in FIG. 2, such as BN 220, IN 230, SN 240.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for validating an authenticity of an item to be purchased in a transaction, the method comprising:
receiving a request for a purchase of at least one item from a purchasing node;
requesting at least one authentication tokens from a token generator, wherein
the at least one authentication token is generated based on a ledger, and
each of the at least one authentication token corresponds to one of the at least one item to be purchased;
sending the at least one authentication token to a provider node;
performing a verification of the at least one authentication token for authentication of the provider node as a legitimate source; and
upon verification of the at least one authentication tokens completing a purchase of the item.

2. The method of claim 1, wherein
the purchasing node is a buyer node, and wherein the
the buyer node is a final node in the ledger to which a purchase of the at least one item is directed to.

3. The method of claim 1, wherein the purchasing node is an intermediary node, wherein the intermediary node receives the at least one item from the provider node for transfer to the purchasing node.

5. The method of claim 1, wherein the provider node is one of a seller node or an intermediary node, and wherein the seller node is a node that is an original creator of the at least one item; and the intermediary node transfers the at least one item to the purchasing node.

6. The method of claim 1, wherein the ledger is any one of: a database ledger, an immutable ledger, or a fault tolerant ledger.

7. The method of claim 6, wherein the immutable ledger includes a blockchain.

8. The method of claim 1, wherein the purchasing node and the provider node are coupled to each other by a communication network.

9. A non-transitory computer readable medium having stored thereon instructions for causing a processing circuitry to execute the method of claim 1.

10. A method for validating an authenticity of an item to be purchased in a transaction, comprising:
receiving a request for purchasing one or more goods from a provider node;
determining whether an authentication token generated based on a ledger has been received;
upon determining that the authentication token has been received, completing the transaction.

11. The method of claim 10, where an alert is generated, upon determining that the authentication token has not been received.

12. The method of claim 10, wherein the ledger is any one of: a database ledger, an immutable ledger, or a fault tolerant ledger.

13. The method of claim 12, wherein the immutable ledger includes a blockchain.

14. A non-transitory computer readable medium having stored thereon instructions for causing a processing circuitry to execute the method of claim 1.

15. A system for validating an authenticity of an item to be purchased in a transaction, the system comprising:
a processing circuitry; and
a memory, the memory containing instructions that, when executed by the processing circuitry, configure the system to:
receive a request for a purchase of at least one item from a purchasing node;
request at least one authentication tokens from a token generator, wherein the at least one authentication token is generated based on a ledger, and each of the at least one authentication token corresponds to one of the at least one item to be purchased;
send the at least one authentication token to a provider node;
perform a verification of the at least one authentication token for authentication of the provider node as a legitimate source; and
upon verification of the at least one authentication tokens, completing a purchase of the item.

16. The system of claim 15, wherein the purchasing node is one of: a buyer node or an intermediary node; the buyer node is a final node to which a purchase of the at least one item is directed to; and the intermediary node receives the at least one item from the provider node for transfer to the purchasing node.

17. The system of claim 15, wherein the provider node is one of a seller node or an intermediary node, wherein: the seller node is a node that is an original creator of the at least one item; and the intermediary node transfers the at least one item to the purchasing node.

18. The system of claim 15, wherein the ledger is one of: a database ledger, an immutable ledger or a fault tolerant ledger.

19. The system of claim 18, wherein the immutable ledger include a blockchain.

20. A system for validating an authenticity of an item to be purchased in a transaction, the system comprising:
a network;
at least one purchasing node communicatively coupled to the communication network;
at least one provider node communicatively coupled to the communication network;
a token generator (TG) communicatively coupled to the communication network, wherein:
the TG is configured to generate authorization tokens in a number requested by the at least one purchasing node; and
the authentication tokens are generated based on a ledger; and
a token authentication server (TAS) connected to the network, wherein the TAS is configured to authenticate the authorization tokens upon receiving a request from the at least one purchasing node; wherein, the at least one purchasing node is configured to request an authentication token from the at least one provider node for each of the item, and to request an authenticity check of the authentication token received from the at least one provider node; and the at least one provider node is configured to request from the TG an authentication token for the item, and to provide the authentication token to the at least one purchasing node.
